(19) United States
(12) Patent Application Publication
(10) Pub. No.: US 2026/0318507 A1
(43) Pub. Date: Oct. 15, 2026

(54) INTELLIGENT LIGHTING FIXTURE AND CONTROL METHOD FOR INTELLIGENT LIGHTING FIXTURE

(71) Applicant: Luxshare Precision Industry Company Limited, SHENZHEN (CN)

(72) Inventors: Hsisheng HSIA, SHENZHEN (CN); Jhihli LIN, SHENZHEN (CN)

(73) Assignee: Luxshare Precision Industry Company Limited, SHENZHEN (CN)

(21) Appl. No.: 19/373,940

(22) Filed: Oct. 30, 2025

(30) Foreign Application Priority Data
Apr. 11, 2025 (CN) 202510458316.3

(51) Int. Cl. F21V 14/06

(52) U.S. Cl. CPC F21V 14/06

(57) ABSTRACT

Provided are an intelligent lighting fixture and a control method therefor, the intelligent lighting fixture includes a control module, multiple light-emitting modules, a lens module, an adjustment module and a scenario obtaining module; the light-emitting modules are arranged in an array to form a light-emitting region; the adjustment module is arranged on the same side of the light-exit paths of the light-emitting modules, the scenario obtaining module is configured to obtain a current application scenario of a user and obtain an adjustment strategy according to the current application scenario; the control module is configured to output a first control signal according to the adjustment strategy, and the adjustment module is configured to adjust the spacing between the lens module and the light-emitting modules in the light-emitting region according to the first control signal to adjust the illumination range output by the light-emitting modules to a target region.

### CROSS-REFERENCE TO RELATED APPLICATION(S)

This application claims priority to Chinese Patent Application No. 202510458316.3 filed Apr. 11, 2025, the disclosure of which is incorporated herein by reference in its entirety.

### TECHNICAL FIELD

Embodiments of the present disclosure relate to the field of lighting and, in particular, to an intelligent lighting fixture and a control method for an intelligent lighting fixture.

### BACKGROUND

In different application scenarios, a lighting fixture serves various purposes, such as reading lighting, decorative lighting and supplemental lighting. However, the beam dispersion range of a conventional lighting fixture is typically fixed and cannot be adjusted according to specific application scenarios. Therefore, the lighting fixture has a monotonous application scenario and fails to meet diverse application requirements.

### SUMMARY

An embodiment of the present application provides an intelligent lighting fixture. The intelligent lighting fixture includes a control module, multiple light-emitting modules, a lens module, an adjustment module and a scenario obtaining module. The multiple light-emitting modules are arranged in an array to form a light-emitting region. In the light-emitting region, the adjustment module is arranged on the same side of the light-exit paths of the light-emitting modules, the adjustment module corresponds to the axis of the light-exit paths of the light-emitting modules, and the lens module is arranged on the adjustment module; the control module is connected to the adjustment module and the scenario obtaining module; the scenario obtaining module is configured to obtain a current application scenario of a user and output the current application scenario to the control module, and the control module is configured to select an adjustment strategy for the lighting fixture according to the current application scenario. The control module is configured to output a first control signal to the adjustment module according to the adjustment strategy, and the adjustment module is configured to adjust the spacing between the lens module and the light-emitting modules in the light-emitting region according to the first control signal to adjust the illumination range output by the light-emitting modules to a target region.

An embodiment of the present disclosure provides a control method for an intelligent lighting fixture. The intelligent lighting fixture includes a control module, multiple light-emitting modules, a lens module, an adjustment module and a scenario obtaining module. The light-emitting modules are arranged in an array to form a light-emitting region. The control method includes the following steps. The scenario obtaining module obtains a current application scenario of a user and outputs the current application scenario to the control module. The control module selects an adjustment strategy for the intelligent lighting fixture according to the current application scenario and outputs a first control signal according to the adjustment strategy. The adjustment module adjusts the spacing between the lens module and the light-emitting modules in the light-emitting region according to the first control signal to adjust the illumination range output by the light-emitting modules to a target region.

### BRIEF DESCRIPTION OF DRAWINGS

FIG. 1 is a structural view of an intelligent lighting fixture according to an embodiment of the present disclosure;

FIG. 2 is a schematic diagram of a path of light rays passing through the lens module;

FIG. 3 is a light pattern distribution diagram when no lens module is arranged according to an embodiment of the present disclosure;

FIG. 4 is a light pattern distribution diagram when a lens module is arranged according to an embodiment of the present disclosure;

FIG. 5 is another light pattern distribution diagram when a lens module is arranged according to an embodiment of the present disclosure;

FIG. 6 is a structural view of a light-emitting region of the intelligent lighting fixture according to an embodiment of the present disclosure;

FIG. 7 is a sectional view of an adjustment module of the intelligent lighting fixture according to an embodiment of the present disclosure;

FIG. 8 is a schematic diagram of a simulated light pattern at a spacing according to an embodiment of the present disclosure;

FIG. 9 is another schematic diagram of a simulated light pattern at a spacing according to an embodiment of the present disclosure;

FIG. 10 is another schematic diagram of a simulated light pattern at a spacing according to an embodiment of the present disclosure;

FIG. 11 is another schematic diagram of a simulated light pattern at a spacing according to an embodiment of the present disclosure; and

FIG. 12 is a flowchart of a control method for an intelligent lighting fixture according to an embodiment of the present disclosure.

### DETAILED DESCRIPTION

To illustrate the purpose, technical solutions and advantages of embodiments of the present disclosure more clearly, the technical solutions of embodiments of the present disclosure are described hereinafter clearly and completely in conjunction with the drawings in embodiments of the present disclosure. Apparently, the embodiments described hereinafter are part, not all, of embodiments of the present disclosure. Based on the embodiments of the present disclosure, all other embodiments obtained by those of ordinary skill in the art without any creative efforts are within the scope of the present disclosure.

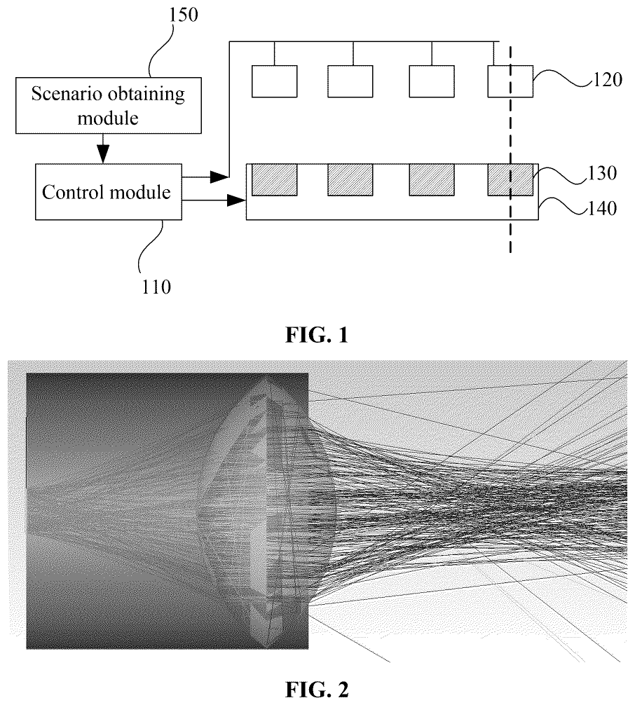

FIG. 1 is a structural view of an intelligent lighting fixture according to an embodiment of the present disclosure. As shown in FIG. 1, the intelligent lighting fixture includes a control module 110, multiple light-emitting modules 120, a lens module 130, an adjustment module 140 and a scenario obtaining module 150.

The light-emitting modules 120 are arranged in an array to form a light-emitting region.

In the light-emitting region, the adjustment module 140 is arranged on the same side of the light-exit paths of the light-emitting modules 120, the adjustment module 140 corresponds to the axis of the light-exit paths of the light-emitting modules 120, and the lens module 130 is arranged on the adjustment module 140; the control module 110 is connected to the adjustment module 140 and the scenario obtaining module 150; the scenario obtaining module 150 is configured to obtain the current application scenario of a user and output the current application scenario to the control module 110, and the control module 110 is configured to select an adjustment strategy of the lighting fixture according to the current application scenario.

The control module 110 is configured to output a first control signal to the adjustment module 140 according to the adjustment strategy, and the adjustment module 140 is configured to adjust the spacing between the lens module 130 and the light-emitting modules 120 in the light-emitting region according to the first control signal to adjust the illumination range output by the light-emitting modules 120 to a target region.

In one or more embodiments, the light-emitting module 120 is a light source output module. The light-emitting module 120 may be a light-emitting diode (LED) light-emitting unit. The number of LED light-emitting units in the light-emitting module 120 may be one or more, that is, the light-emitting module 120 may be composed of one LED light-emitting unit or the light-emitting module 120 may be composed of multiple LED light-emitting units. The number of LED light-emitting units in the light-emitting module 120 may be set according to the requirements of light-emitting power, which is not limited herein. A light-emitting region of a certain area may be obtained by arranging the light-emitting modules 120 in an array. The maximum brightness requirement of the light-emitting region may be designed and adjusted according to the number of the light-emitting modules 120 or the number of LED light-emitting units in the light-emitting modules 120. For example, the array arrangement manner may be designed according to the requirement for the shape of the light-emitting region. For example, the array may be a matrix array, a circular array, a regular polygon array or the like, which is not limited herein.

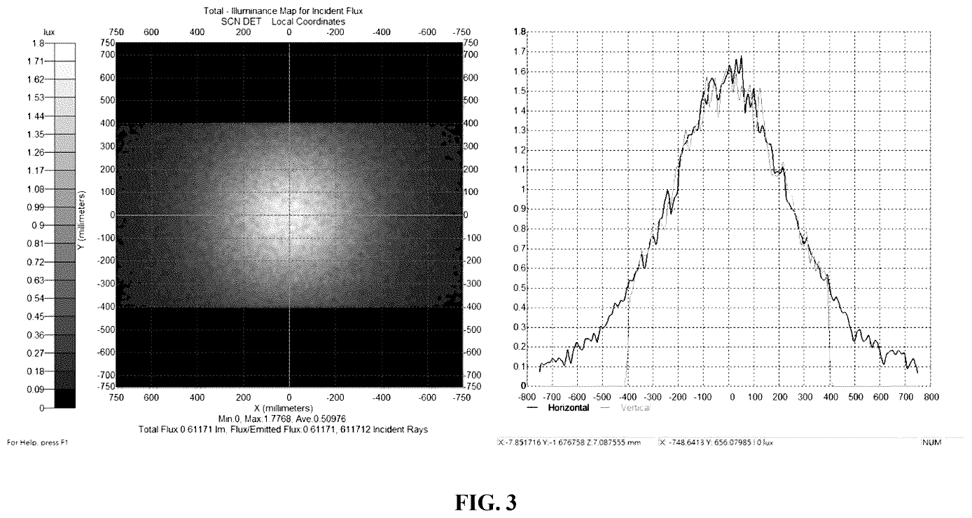

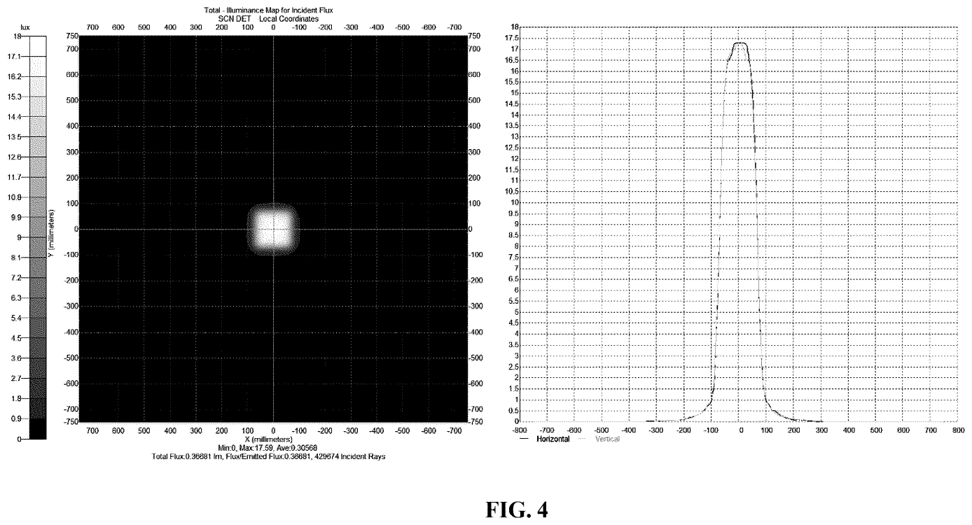

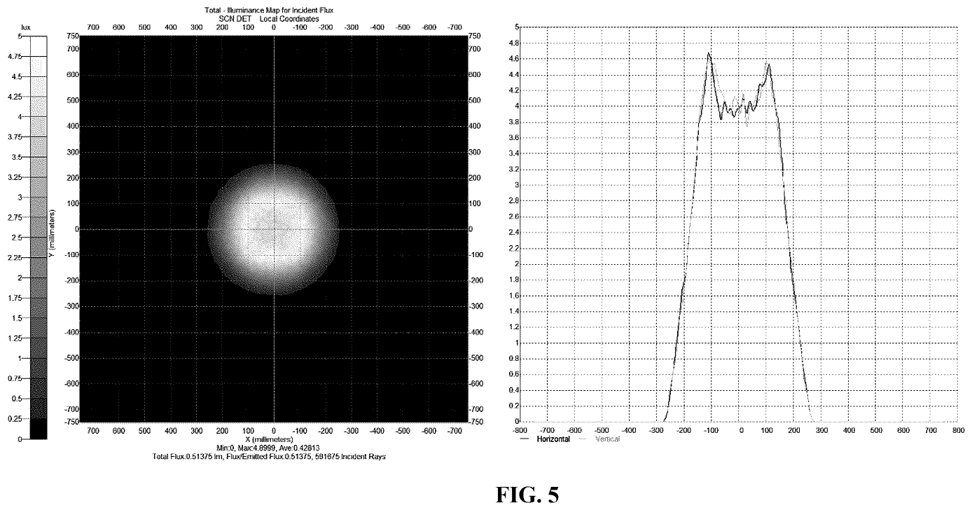

The adjustment module 140 is arranged on the same side of the light-exit paths of the light-emitting modules 120, the lens module 130 is arranged on the adjustment module 140, and the lens module 130 may correspond to the axis of the light-exit path of each light-emitting module 120, that is, the light-exit path of the light-emitting modules 120 passes through the lens module 130. The light transmission path is changed by the lens module 130 to disperse light rays and focus light rays. FIG. 2 is a schematic diagram of a path of light rays passing through the lens module. With reference to FIG. 2, after the light rays pass through the lens module 130, dispersed light rays and focused light rays may be generated. For example, the lens module 130 may be an optical system composed of a single lens or an optical system composed of a lens array in which multiple lenses are arranged, which is not limited herein, as long as the lens module 130 may shape the light rays. Therefore, it can be seen that the illumination range in which the light rays are irradiated to the target region may be changed by adjusting the spacing between the lens module 130 and the light-emitting modules 120 when the lighting fixture emits light to the height of the target region. To facilitate understanding, for example, the lighting fixture may be a desk lamp. It is assumed that the height of the desk lamp from the desktop is 45 cm, and the desktop is a target region for illumination. FIG. 3 is a light pattern distribution diagram when no lens module is arranged according to an embodiment of the present disclosure. The X-axis identifies the dimension distribution in the X-axis direction on the plane, and the scales from left to right are denoted as 750, 600, 400, 200, 0, −200, −400, −600, and −750, respectively, in millimeters (mm). The Y-axis identifies the dimension distribution in the Y-axis direction on the plane, and the scales from top to bottom are denoted as 750, 700, 600, 500, 400, 300, 200, 100, 0, −100, −200, −300, −400, −500, −600, −700, and −750, respectively, in mm. The illuminance distribution is identified from black to white on the left side of the figure, and the scales are 0, 0.09, 0.18, 0.27, 0.36, 0.45, 0.54, 0.63, 0.72, 0.81, 0.9, 0.99, 1.08, 1.17, 1.26, 1.35, 1.44, 1.53, 1.62, 1.71, and 1.8, respectively, in Lux. In the curve graph, the vertical coordinates are the illuminance, ranging from 0 to 1.8, at intervals of 0.1, in Lux, and the horizontal coordinates are the dimension length, ranging from −800 to 800, at intervals of 100, in mm. The dark curve is the distribution curve of the illuminance in the X-axis direction with the plane dimension, and the light curve is the distribution curve of the illuminance in the Y-axis direction with the plane dimension. It can be seen from the light pattern distribution diagram that the highest illumination is 1.77 Lux and the illumination range is relatively dispersed. FIG. 4 is a light pattern distribution diagram when a lens module is arranged according to an embodiment of the present disclosure. The X-axis identifies the dimension distribution in the X-axis direction on the plane, and the scales from left to right are denoted as 700, 600, 500, 400, 300, 200, 100, 0, −100, −200, −300, −400, −500, −600, and −700, respectively, in mm. The Y-axis identifies the dimension distribution in the Y-axis direction on the plane, and the scales from top to bottom are denoted as 750, 700, 600, 500, 400, 300, 200, 100, 0, −100, −200, −300, −400, −500, −600, −700, and −750, respectively, in mm. The illuminance distribution is identified from black to white on the left side of the figure, and the scales are 0, 0.9, 1.8, 2.7, 3.6, 4.5, 5.4, 6.3, 7.2, 8.1, 9, 9.9, 10.8, 11.7, 12.6, 13.5, 14.4, 15.3, 16.2, 17.1, and 18, respectively, in Lux. In the curve graph, the vertical coordinates are the illuminance, ranging from 0 to 18, at intervals of 0.5, in Lux, and the horizontal coordinates are the dimension length, ranging from −800 to 800, at intervals of 100, in mm. The dark curve is the distribution curve of the illuminance in the X-axis direction with the plane dimension, and the light curve is the distribution curve of the illuminance in the Y-axis direction with the plane dimension. It can be seen from the light pattern distribution diagram that the light-emitting modules 120 are in the far focus state, an LED image may be projected onto the desktop, the highest illumination is 17.59 Lux, and the illumination range is relatively concentrated. FIG. 5 is another light pattern distribution diagram when a lens module is arranged according to an embodiment of the present disclosure. The X-axis identifies the dimension distribution in the X-axis direction on the plane, and the scales from left to right are denoted as 750, 700, 600, 500, 400, 300, 200, 100, 0, −100, −200, −300, −400, −500, −600, −700, and −750, respectively, in mm. The Y-axis identifies the dimension distribution in the Y-axis direction on the plane, and the scales from top to bottom are denoted as 750, 700, 600, 500, 400, 300, 200, 100, 0, −100, −200, −300, −400, −500, −600, −700, and −750, respectively, in mm. The illuminance distribution is identified from black to white on the left side of the figure, and the scales are 0, 0.25, 0.5, 0.75, 1, 1.25, 1.5, 1.75, 2, 2.25, 2.5, 2.75, 3, 3.25, 3.75, 4, 4.25, 4.5, 4.75, and 5, respectively, in Lux. In the curve graph, the vertical coordinates are the illuminance, ranging from 0 to 5, at intervals of 0.2, in Lux, and the horizontal coordinates are the dimension length, ranging from −800 to 800, at intervals of 100, in mm. The dark curve is the distribution curve of the illuminance in the X-axis direction with the plane dimension, and the light curve is the distribution curve of the illuminance in the Y-axis direction with the plane dimension. By adjusting the spacing between the light-emitting modules 120 and the lens module 130, a relatively soft light pattern distribution diagram may be obtained, with the highest illuminance of 4.9 Lux and the overall luminous flux of 0.5138 lm. As can be seen from the above light pattern diagram, when the light-emitting modules 120 are in the far focus state, an LED image may be projected onto the desktop, and when the light-emitting modules 120 are at one focal length, the light rays exhibit a dispersion pattern. Based on the focal length formula, simulations show that a larger or specific illumination range may be achieved by adjusting the spacing between the lens module 130 and the light-emitting modules 120; that is, the spacing between the lens module 130 and the light-emitting modules 120 has a certain mapping relationship with the illumination range.

Therefore, the adjustment module 140 is controlled to adjust the spacing between the lens module 130 and the light-emitting modules 120 according to the first control signal sent from the control module 110, thereby achieving the adjustment of the illumination range. The first control signal here may be a current signal, a voltage signal or a digitally processed pulse-width modulation signal. The first control signal may be generated according to custom manual input to meet the requirement of the user for the custom adjustment of the illumination range. The first control signal may also be automatically generated. The intelligent lighting fixture is also provided with the scenario obtaining module 150. The scenario obtaining module 150 may be provided with a corresponding image acquisition unit. The current action characteristic of the user may be obtained by using an image acquisition technology, and the current application scenario of the user may be inferred in conjunction with image processing and artificial intelligence control, for example, reading, writing or doing handwork under the lighting fixture of the intelligent desk lamp. The scenario obtaining module 150 may send the current application scenario to the control module 110, and the control module 110 may perform matching on the current application scenario with a preset application scenario and call an adjustment strategy corresponding to the preset application scenario if the current application scenario matches the preset application scenario. The adjustment strategy may include parameters such as the distance of the lighting fixture from the target region and the spacing between the lens module 130 and the light-emitting modules 120. The control module 110 outputs the first control signal according to the adjustment strategy, and the adjustment module 140 may adjust the spacing between the lens module 130 and the light-emitting modules 120 in the light-emitting region according to the first control signal to adjust the illumination range output by the light-emitting modules 120 to the target region.

In the intelligent lighting fixture provided by the embodiments of the present disclosure, by arranging the lens module 130 on the light-exit path of the light-emitting modules 120, the current application scenario of the user is obtained by using the scenario obtaining module 150, and the adjustment strategy of the lighting fixture is obtained according to the current application scenario, and the adjustment module 140 is controlled by using the control module 110 according to the adjustment strategy to implement the adjustment of the spacing between the lens module 130 and the light-emitting modules 120, thereby achieving the automatic adjustment of the illumination range output by the light-emitting modules 120 to the target region under different application scenarios and meeting various usage scenarios.

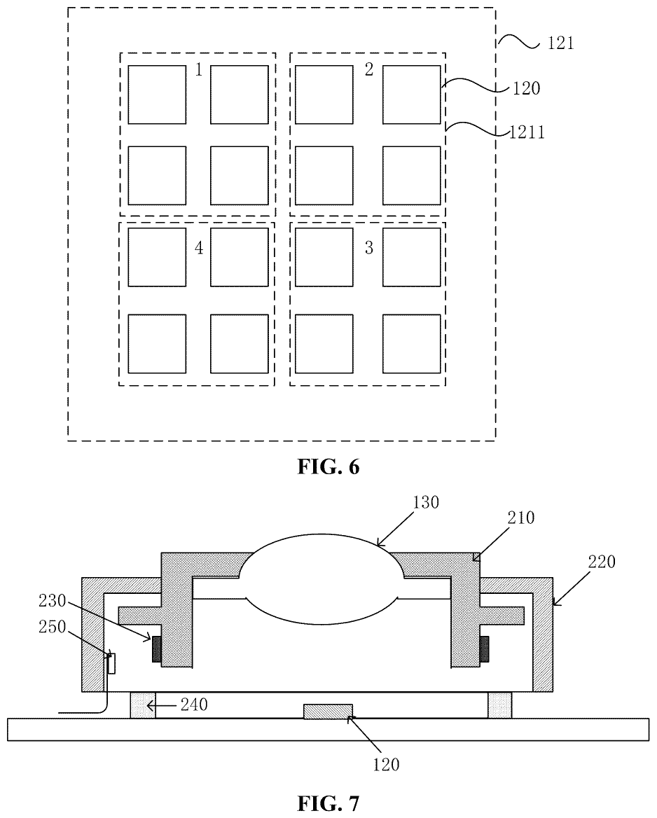

Based on the preceding embodiments, FIG. 6 is a structural view of a light-emitting region of the intelligent lighting fixture according to an embodiment of the present disclosure. As shown in FIG. 6, the light-emitting region 121 includes multiple light-emitting sub-regions 1211, and each light-emitting sub-region 1211 includes at least one light-emitting module 120.

The adjustment module 140 is provided with multiple adjustment sub-regions corresponding to the multiple light-emitting sub-regions 1211, and each adjustment sub-region includes at least one lens module 130.

The first control signal includes multiple first control sub-signals.

The adjustment module 140 is configured to adjust the spacing between the at least one lens module 130 and the at least one light-emitting module 120 in each adjustment sub-region according to the corresponding first control sub-signal to adjust the illumination range output by the at least one light-emitting module 120 in the light-emitting sub-region 1211 to the target region.

For example, in the figures, taking the arrangement of light-emitting modules 120 in a 4*4 array to form the light-emitting region 121 as an example for description, the light-emitting region 121 may be divided into multiple light-emitting sub-regions 1211 according to the control requirement for the light-emitting position. In this embodiment of the present disclosure, each light-emitting sub-region 1211 includes 2*2 light-emitting modules 120, and the light-emitting region 121 may be divided into four light-emitting sub-regions 1211, numbered 1, 2, 3 and 4, respectively. The adjustment module 140 is also divided into adjustment sub-regions corresponding to the light-emitting sub-regions 1211, and the lens module 130 in each adjustment sub-region corresponds to the light-emitting modules 120 in each light-emitting sub-region 1211. By separately controlling the spacing between the lens module 130 in each adjustment sub-region and the corresponding light-emitting modules 120, the adjustment of the illumination range of each light-emitting sub-region 1211 in the light-emitting region 121 may be achieved. Multiple first control sub-signals may be allocated according to the number of adjustment sub-regions, and each first control sub-signal is connected to a corresponding adjustment sub-region. For example, in some application scenarios, if the illumination ranges of the light-emitting sub-regions 1211 numbered 1, 2, 3 and 4 need to be adjusted according to the adjustment strategy, among which the light-emitting sub-regions 1211 numbered 2, 3 and 4 have the same illumination range while the light-emitting sub-region 1211 numbered 1 has a larger illumination range than the others, the control module 110 may output four first control sub-signals, the four first control sub-signals are separately sent to the adjustment sub-regions each corresponding to a respective one of the light-emitting sub-regions 1211 numbered 1, 2, 3 and 4, and each adjustment sub-region corresponding to the respective one of the light-emitting sub-regions 1211 numbered 1, 2, 3 and 4 adjusts the spacing between the lens module 130 in the adjustment sub-region and the corresponding light-emitting modules 120 according to the corresponding first control sub-signal, thereby achieving the adjustment of the illumination ranges at different positions within the same light-emitting region 121.

In one or more embodiments, the control module 110 is connected to the light-emitting modules 120. The control module 110 is further configured to output a second control signal to the light-emitting modules 120 according to the adjustment strategy, and the light-emitting modules 120 are configured to adjust a light-exit parameter according to the second control signal.

In one or more embodiments, the adjustment strategy may further include light-exit parameters such as color temperature and light intensity of the light-emitting modules 120. That is, the control module 110 may output the second control signal according to the adjustment strategy to control the light-emitting modules 120 to adjust the light-exit parameters such as color temperature and light intensity, thereby achieving the adjustment of the illumination range of the intelligent lighting fixture and the adjustment of the light-exit parameters and further enriching the application scenarios.

In conjunction with FIG. 6, the second control signal includes multiple second control sub-signals, and the light-emitting modules 120 in each light-emitting sub-region 1211 are configured to adjust the light-exit parameter of the light-emitting modules 120 in each light-emitting sub-region 1211 according to the corresponding second control sub-signal.

In one or more embodiments, multiple second control sub-signals may be allocated according to the number of light-emitting sub-regions 1211, and each second control sub-signal is connected to the light-emitting modules 120 in a corresponding light-emitting sub-region 1211. For example, in some application scenarios, if the light-exit parameters of the light-emitting sub-regions 1211 numbered 1, 2, 3 and 4 need to be adjusted according to the adjustment strategy, among which the light-emitting modules 120 in the light-emitting sub-regions 1211 numbered 2, 3 and 4 have the same light intensity while the light-emitting modules 120 in the light-emitting sub-region 1211 numbered 1 have lower light intensity than the others, the control module 110 may output four second control sub-signals, the four second control sub-signals are sent to the light-emitting modules 120 in each of the light-emitting sub-regions 1211 numbered 1, 2, 3 and 4, respectively, and the light-emitting modules 120 in each of the light-emitting sub-regions 1211 numbered 1, 2, 3 and 4 adjust their light-exit parameters according to the corresponding second control sub-signal, thereby adjusting the brightness of the light-emitting region 121 of the lighting fixture according to the application scenarios of the user and achieving the effects of saving electricity and avoiding light pollution.

Based on the preceding embodiments, FIG. 7 is a sectional view of an adjustment module of the intelligent lighting fixture according to an embodiment of the present disclosure. With reference to FIG. 7, the adjustment module 140 includes multiple adjustment units.

The adjustment units are in one-to-one correspondence with the light-emitting modules 120, and each adjustment unit is arranged on the axis on the same side of the light-exit path of the corresponding light-emitting module 120.

An adjustment unit includes a lens barrel 210, a support barrel 220, a current coil 230 and a magnetic unit 240.

The lens module 130 is fixedly arranged in the lens barrel 210, and the lens barrel 210 is sleeved in the support barrel 220. A side of the support barrel 220 facing away from the light-emitting modules 120 is provided with a first opening, and the lens barrel 210 is capable of moving relatively in the first opening under the action of an external force. A sidewall of the lens barrel 210 is provided with a limit protrusion for limiting the relative movement distance of the lens barrel 210.

The current coil 230 is arranged on a sidewall of the lens barrel 210 and on a side of the limit protrusion facing the light-emitting modules 120. The magnetic unit 240 is arranged on a side of the current coil 230 facing the light-emitting modules 120. The current coil 230 is configured to generate a magnetic field signal according to the first control signal and cooperate with the magnetic unit 240 to provide a force driving the lens barrel 210 to relatively move by a preset distance so that the spacing between the lens module 130 and the light-emitting modules 120 can be adjusted.

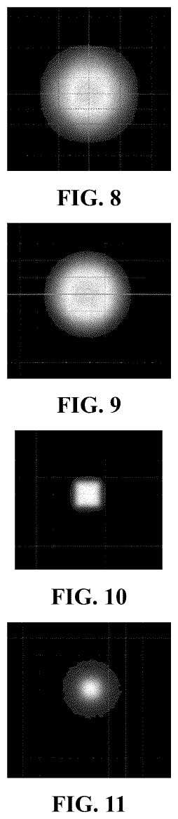

In one or more embodiments, the adjustment units and the light-emitting modules 120 are arranged in the same manner. Each adjustment unit corresponds to one light-emitting module 120, and the adjustment unit is located on a side of the light-exit path of the corresponding light-emitting module 120. In conjunction with FIG. 7, the adjustment unit includes a lens barrel 210, a support barrel 220, a current coil 230 and a magnetic unit 240. The lens barrel 210 is configured to carry the lens module 130, and the lens module 130 is mounted on a side of the lens barrel 210 facing away from the light-emitting modules 120. The lens module 130 is capable of moving with the lens barrel 210. The lens barrel 210 is located in the support barrel 220, and at least a portion of the lens barrel 210 is capable of relatively moving in the first opening of the support barrel 220 under the action of an external force. Since the light-emitting modules 120 are fixed, the spacing between the lens module 130 and the light-emitting modules 120 may be adjusted by moving the lens barrel 210. To avoid the disengagement of the lens barrel 210 when moving in the direction facing away from the light-emitting modules 120, a limit protrusion may be arranged on the sidewall of the lens barrel 210. For example, to avoid the disengagement of the lens barrel 210 when moving in the direction facing the light-emitting modules 120, the length dimension of the lens barrel 210 may be set to be larger than the length dimension of the support barrel 220, and thus, when the lens barrel 210 moves towards the light-emitting modules 120, the lens barrel 210 is limited by the length of the sidewall of the lens barrel 210. The first control signal may be a current signal directly; alternatively, a current signal may be indirectly generated by the first control signal. When the current passes through the current coil 230, the current coil 230 generates a magnetic field signal, the magnetic unit 240 may provide an external magnetic field, and a Lorentz force is generated under the interaction between the current and the external magnetic field. By adjusting the direction and intensity of the current flowing into the current coil 230, the direction of the Lorentz force may be adjusted, and thus, the movement direction of the lens barrel 210 may be adjusted, thereby achieving the adjustment of the spacing between the lens module 130 and the light-emitting modules 120. According to the usage requirements, the lens module 130 may be adjusted to be away from the light-emitting modules 120 or move towards the light-emitting modules 120 to adjust the light pattern, thereby expanding or concentrating the illumination range. FIGS. 8 to 11 are schematic diagrams of simulated light patterns at different spacings according to embodiments of the present disclosure. As can be seen from the figures, different illumination ranges may be obtained by adjusting the spacing between the lens module 130 and the light-emitting modules 120. When the adjustment sub-regions are arranged, the adjustment units in each adjustment sub-region may access the same first control sub-signal, thereby simultaneously controlling the adjustment units in the adjustment sub-region.

With continued reference to FIG. 7, in one or more embodiments, the adjustment unit further includes a Hall sensing unit 250.

The Hall sensing unit 250 is arranged on an inner wall of the support barrel 220 and on a side facing the current coil 230. The Hall sensing unit 250 is connected to the control module 110, and the Hall sensing unit 250 is configured to detect the magnetic field signal and feed back the magnetic field signal to the control module 110.

The control module 110 is further configured to determine the spacing between the lens module 130 and the light-emitting modules 120 according to the fed back magnetic field signal.

In one or more embodiments, when the lens barrel 210 moves, the distribution of the magnetic field signal generated by the current coil 230 changes, and thus, the magnitude and direction of the potential difference detected by the Hall sensing unit 250 change. The Hall sensing unit 250 may feed back the detected change of the magnetic field signal to the control module 110, and the control module 110 may obtain the position of the lens barrel 210 through mathematical processing according to the change of the magnetic field signal. If it is detected that the spacing between the lens module 130 and the light-emitting modules 120 is under-adjusted or over-adjusted according to the position of the lens barrel 210, the control module 110 may send a corresponding compensation signal to perform a fine adjustment on the adjustment module 140 again.

In the preceding embodiments, the scenario obtaining module 150 includes an image acquisition unit, and the control module 110 includes an artificial intelligence processing unit. The image acquisition unit is configured to acquire a status characteristic of the user in the target region. The artificial intelligence processing unit has a preset application scenario, and the artificial intelligence processing unit is connected to the image acquisition unit. The artificial intelligence processing unit is configured to perform matching according to the status characteristic and the preset application scenario to obtain the current application scenario and call the adjustment strategy according to the current application scenario.

In one or more embodiments, the image acquisition unit may be a camera unit or an imaging unit. The image acquisition unit may obtain the action characteristic of the user by using the image acquisition technology. The action characteristic may include the gesture of the user, and the gesture encompasses a dynamic gesture or a static gesture, for example, upward swiping, downward swiping and pointing in specific directions. The action characteristic may further include the action of the user, for example, head-raising, head-lowering, head-turning and arm-raising actions. The artificial intelligence processing unit may infer the current application scenario of the user through image processing and artificial intelligence control. The current application scenario may be the adjustment of the illumination range or the light-exit parameter through gestures. The current application scenario may also be a specific application scenario, for example, reading, writing or doing handwork under the lighting fixture of the intelligent desk lamp. The control module 110 may perform matching on the current application scenario and the preset application scenario and call an adjustment strategy corresponding to the preset application scenario if the current application scenario matches the preset application scenario. The adjustment strategy may include parameters such as the distance of the lighting fixture from the target region, the spacing between the lens module 130 and the light-emitting modules 120, and the color temperature and light intensity of the light-emitting modules 120. The control module 110 outputs the first control signal according to the adjustment strategy, and the adjustment module 140 may adjust the spacing between the lens module 130 and the light-emitting modules 120 in the light-emitting region 121 according to the first control signal to adjust the illumination range output by the light-emitting modules 120 to the target region.

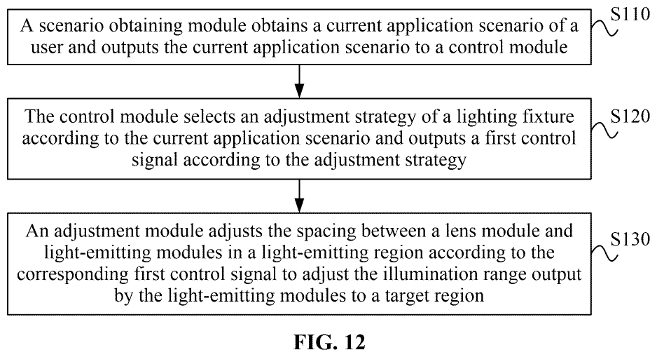

FIG. 12 is a flowchart of a control method for an intelligent lighting fixture according to an embodiment of the present disclosure. This embodiment may be applied to the scenario of controlling the illumination range of an intelligent lighting fixture. The method may be performed by an intelligent lighting fixture which may be implemented in software and/or hardware. The method includes steps S110 to S130.

In S110, the scenario obtaining module obtains a current application scenario of a user and outputs the current application scenario to the control module.

In one or more embodiments, the scenario obtaining module 150 may be provided with a corresponding image acquisition unit. The current action characteristic of the user may be obtained by using the image acquisition technology, and the current application scenario of the user may be inferred in conjunction with image processing and artificial intelligence control, for example, reading, writing or doing handwork under the lighting fixture of an intelligent desk lamp. The scenario obtaining module may output the current application scenario to the control module.

In S120, the control module selects an adjustment strategy for the lighting fixture according to the current application scenario and outputs a first control signal according to the adjustment strategy.

The control module performs matching on the output current application scenario and the preset application scenario and calls an adjustment strategy corresponding to the preset application scenario if the current application scenario matches the preset application scenario. The adjustment strategy may include parameters such as the distance of the lighting fixture from the target region and the spacing between the lens module 130 and the light-emitting modules 120. The control module then outputs the first control signal according to the adjustment strategy.

In S130, the adjustment module adjusts the spacing between the lens module and the light-emitting modules in the light-emitting region according to the first control signal to adjust the illumination range output by the light-emitting modules to a target region.

In one or more embodiments, the adjustment module 140 is arranged on the side of the light-exit paths of the light-emitting modules 120, the lens module 130 is arranged on the adjustment module 140, and the lens module 130 may correspond to the axis of the light-exit paths of the light-emitting modules 120; that is, the light-exit paths of the light-emitting modules 120 pass through the lens module 130. The light transmission path is changed by the lens module 130 to disperse light rays and focus light rays. It can be seen that the illumination range in which the light rays are irradiated to the target region may be changed by adjusting the spacing between the lens module 130 and the light-emitting modules 120 when the lighting fixture emits light to a certain height in the target region.

In the control method for an intelligent lighting fixture provided by the embodiments of the present disclosure, by obtaining, through the scenario obtaining module 150, the current application scenario of the user and obtaining the adjustment strategy for the lighting fixture according to the current application scenario and controlling, through the control module 110, the adjustment module 140 according to the adjustment strategy, the spacing between the lens module 130 and the light-emitting modules 120 is adjusted, thereby achieving the automatic adjustment of the illumination range output by the light-emitting modules 120 to the target region under different application scenarios and meeting various usage scenarios.

In one or more embodiments, the light-emitting region 121 includes multiple light-emitting sub-regions 1211, and each light-emitting sub-region 1211 includes at least one light-Emitting module 120.

The adjustment module 140 includes multiple adjustment sub-regions corresponding to the light-emitting sub-regions 1211, and each adjustment sub-region includes at least one lens module 130. The first control signal includes multiple first control sub-signals.

The control method includes the following step.

The adjustment module 140 adjusts the spacing between the at least one lens module 130 and the at least one light-emitting module 120 in the adjustment sub-region according to a corresponding first control sub-signal to adjust the illumination range output by the at least one light-emitting module 120 in the light-emitting sub-region 1211 to the target region.

In conjunction with FIG. 6, taking the arrangement of light-emitting modules 120 in a 4*4 array to form the light-emitting region 121 as an example for description, the light-emitting region 121 may be divided into multiple light-emitting sub-regions 1211 according to the control requirement for the light-emitting position. In this embodiment of the present disclosure, each light-emitting sub-region 1211 includes 2*2 light-emitting modules 120, and the light-emitting region 121 may be divided into four light-emitting sub-regions 1211, numbered 1, 2, 3 and 4, respectively. The adjustment module 140 is also divided into adjustment sub-regions corresponding to the light-emitting sub-regions 1211, and the lens module 130 in each adjustment sub-region corresponds to the light-emitting modules 120 in each light-emitting sub-region 1211. By separately controlling the spacing between the lens module 130 in each adjustment sub-region and the corresponding light-emitting modules 120, the adjustment of the illumination range of each light-emitting sub-region 1211 in the light-emitting region 121 can be achieved. Multiple first control sub-signals may be allocated according to the number of adjustment sub-regions, and each first control sub-signal is connected to a corresponding adjustment sub-region. For example, in some application scenarios, if the illumination ranges of the light-emitting sub-regions 1211 numbered 1, 2, 3 and 4 need to be adjusted according to the adjustment strategy, among which the light-emitting sub-regions 1211 numbered 2, 3 and 4 have the same illumination range while the light-emitting sub-region 1211 numbered 1 has a larger illumination range than the others, the control module 110 may output four first control sub-signals, the four first control sub-signals are separately sent to the adjustment sub-regions each corresponding to a respective one of the light-emitting sub-regions 1211 numbered 1, 2, 3 and 4, and each adjustment sub-region corresponding to the respective one of the light-emitting sub-regions 1211 numbered 1, 2, 3 and 4 adjusts the spacing between the lens module 130 in the adjustment sub-region and the corresponding light-emitting modules 120 according to the corresponding first control sub-signals, thereby achieving the adjustment of the illumination ranges at different positions within the same light-emitting region 121.

In one or more embodiments, the scenario obtaining module 150 includes an image acquisition unit, and the control module 110 includes an artificial intelligence processing unit.

The control method includes the following steps.

The image acquisition unit acquires a status characteristic of the user in the target region.

The artificial intelligence processing unit has a preset application scenario, and the artificial intelligence processing unit performs matching according to the status characteristic and the preset application scenario to obtain the current application scenario and calls the adjustment strategy according to the current application scenario.

In one or more embodiments, the image acquisition unit may be a camera unit or an imaging unit. The image acquisition unit may obtain the action characteristic of the user by using the image acquisition technology. The action characteristic may include the gesture of the user, and the gesture encompasses a dynamic gesture or a static gesture, for example, upward swiping, downward swiping and pointing in specific directions. The action characteristic may further include the action of the user, for example, head-raising, head-lowering, head-turning and arm-raising actions. The artificial intelligence processing unit may infer the current application scenario of the user through image processing and artificial intelligence control. The current application scenario may be the adjustment of the illumination range or the light-exit parameter through gestures. The current application scenario may also be a specific application scenario, for example, reading, writing or doing handwork under the lighting fixture of the intelligent desk lamp. The control module 110 may perform matching on the current application scenario and the preset application scenario and call an adjustment strategy corresponding to the preset application scenario if the current application scenario matches the preset application scenario. The adjustment strategy may include parameters such as the distance of the lighting fixture from the target region, the spacing between the lens module 130 and the light-emitting modules 120, and the color temperature and light intensity of the light-emitting modules 120. The control module 110 outputs the first control signal according to the adjustment strategy, and the adjustment module 140 may adjust the spacing between the lens module 130 and the light-emitting modules 120 in the light-emitting region 121 according to the first control signal to adjust the illumination range output by the light-emitting modules 120 to the target region.

Finally, it is to be noted that the preceding are merely intended to illustrate the technical solutions of the present disclosure and are not intended to limit the present disclosure. Although the present disclosure is described in detail with reference to the embodiments described above, it is to be understood by those of ordinary skill in the art that they can still modify the technical solutions in the preceding embodiments or make equivalent substitutions on part of the technical features therein; however, these modifications or substitutions do not deviate the essence of the corresponding technical solutions from the spirit and scope of the technical solutions in the preceding embodiments of the present disclosure.

What is claimed is:

1. An intelligent lighting fixture, comprising a control module, a plurality of light-emitting modules, a lens module, an adjustment module and a scenario obtaining module;
wherein the plurality of light-emitting modules are arranged in an array to form a light-emitting region;
in the light-emitting region, the adjustment module is arranged on one side of light-exit paths of the plurality of light-emitting modules, the adjustment module corresponds to an axis of the light-exit paths of the plurality of light-emitting modules, and the lens module is arranged on the adjustment module; the control module is connected to the adjustment module and the scenario obtaining module; the scenario obtaining module is configured to obtain a current application scenario of a user and output the current application scenario to the control module, and the control module is configured to select an adjustment strategy for the intelligent lighting fixture according to the current application scenario;
the control module is configured to output a first control signal to the adjustment module according to the adjustment strategy, and the adjustment module is configured to adjust a spacing between the lens module and the plurality of light-emitting modules in the light-emitting region according to the first control signal to adjust an illumination range output by the light-emitting module to a target region.

2. The intelligent lighting fixture according to claim 1, wherein the light-emitting region comprises a plurality of light-emitting sub-regions; each light-emitting sub-region of the plurality of light-emitting sub-regions comprises at least one light-emitting module of the plurality of light-emitting modules;
the adjustment module comprises a plurality of adjustment sub-regions corresponding to the plurality of light-emitting sub-regions; each adjustment sub-region of the plurality of adjustment sub-regions comprises at least one lens module;
the first control signal comprises a plurality of first control sub-signals;
the adjustment module is configured to adjust a spacing between the at least one lens module in each adjustment sub-region and the at least one light-emitting module according to a first control sub-signal corresponding to each adjustment sub-region to adjust an illumination range output by the at least one light-emitting module in each light-emitting sub-region to the target region.

3. The intelligent lighting fixture according to claim 1, wherein the control module is connected to the plurality of light-emitting modules;
the control module is further configured to output a second control signal to the plurality of light-emitting modules according to the adjustment strategy, and the plurality of light-emitting modules are configured to adjust a light-exit parameter according to the second control signal.

4. The intelligent lighting fixture according to claim 3, wherein the light-emitting region comprises a plurality of light-emitting sub-regions; each light-emitting sub-region of the plurality of light-emitting sub-regions comprises at least one light-emitting module of the plurality of light-emitting modules; the second control signal comprises a plurality of second control sub-signals;
the at least one light-emitting module in each light-emitting sub-region is configured to adjust a light-exit parameter of the at least one light-emitting module in each light-emitting sub-region according to a second control sub-signal corresponding to each light-emitting sub-region.

5. The intelligent lighting fixture according to claim 1, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.

6. The intelligent lighting fixture according to claim 2, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.

7. The intelligent lighting fixture according to claim 3, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.

8. The intelligent lighting fixture according to claim 4, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.

9. The intelligent lighting fixture according to claim 5, wherein the adjustment unit further comprises a Hall sensing unit;
the Hall sensing unit is arranged on an inner wall of the support barrel on a side facing the current coil; the Hall sensing unit is connected to the control module, and the Hall sensing unit is configured to detect the magnetic field signal and feed back the magnetic field signal to the control module;
the control module is further configured to determine the spacing between the lens module and the corresponding light-emitting module according to the fed back magnetic field signal.

10. The intelligent lighting fixture according to claim 1, wherein the scenario obtaining module comprises an image acquisition unit, and the control module comprises an artificial intelligence processing unit;
the image acquisition unit is configured to acquire a status characteristic of the user in the target region;
the artificial intelligence processing unit has a preset application scenario, the artificial intelligence processing unit is connected to the image acquisition unit, and the artificial intelligence processing unit is configured to perform matching according to the status characteristic and the preset application scenario to obtain the current application scenario and call the adjustment strategy according to the current application scenario.

11. A control method for an intelligent lighting fixture, wherein the intelligent lighting fixture comprises a control module, a plurality of light-emitting modules, a lens module, an adjustment module and a scenario obtaining module; the plurality of light-emitting modules are arranged in an array to form a light-emitting region; and
the control method comprises:
obtaining, by the scenario obtaining module, a current application scenario of a user, and outputting the current application scenario to the control module;
selecting, by the control module, an adjustment strategy for the intelligent lighting fixture according to the current application scenario, and outputting a first control signal according to the adjustment strategy; and
adjusting, by the adjustment module, a spacing between the lens module and the plurality of light-emitting modules in the light-emitting region according to the first control signal to adjust an illumination range output by the plurality of light-emitting modules to a target region.

12. The control method for the intelligent lighting fixture according to claim 11, wherein the light-emitting region comprises a plurality of light-emitting sub-regions; each light-emitting sub-region of the plurality of light-emitting sub-regions comprises at least one light-emitting module of the plurality of light-emitting modules;
the adjustment module is provided with a plurality of adjustment sub-regions corresponding to the plurality of light-emitting sub-regions; an adjustment sub-region of the plurality of adjustment sub-regions comprises at least one lens module; the first control signal comprises a plurality of first control sub-signals; and
the control method comprises:
adjusting, by the adjustment module, a spacing between the at least one lens module in each adjustment sub-region and the at least one light-emitting module according to a corresponding first control sub-signal of the plurality of first control sub-signals to adjust an illumination range output by the at least one light-emitting module in each light-emitting sub-region to the target region.

13. The control method for the intelligent lighting fixture according to claim 11, wherein the scenario obtaining module comprises an image acquisition unit, and the control module comprises an artificial intelligence processing unit; and
the control method comprises:
acquiring, by the image acquisition unit, a status characteristic of the user in the target region; and
performing, by the artificial intelligence processing unit, matching according to the status characteristic and a preset application scenario in the artificial intelligence processing unit to obtain the current application scenario, and calling the adjustment strategy according to the current application scenario.

14. The control method for the intelligent lighting fixture according to claim 11, wherein the control module is connected to the plurality of light-emitting modules;
the control method comprises:
outputting, by the control module, a second control signal to the plurality of light-emitting modules according to the adjustment strategy, and
adjusting a light-exit parameter of the plurality of light-emitting modules according to the second control signal.

15. The control method for the intelligent lighting fixture according to claim 11, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.

16. The control method for the intelligent lighting fixture according to claim 15, wherein the adjustment unit further comprises a Hall sensing unit;
the Hall sensing unit is arranged on an inner wall of the support barrel on a side facing the current coil; and the Hall sensing unit is connected to the control module;
the method comprises:
detecting, by the Hall sensing unit, the magnetic field signal and feeding back the magnetic field signal to the control module; and
determining, by the control module, the spacing between the lens module and the corresponding light-emitting module according to the fed back magnetic field signal.

17. The control method for the intelligent lighting fixture according to claim 12, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.

18. The control method for the intelligent lighting fixture according to claim 13, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.

19. The control method for the intelligent lighting fixture according to claim 14, wherein the adjustment module comprises a plurality of adjustment units;
the plurality of adjustment units are in one-to-one correspondence with the plurality of light-emitting modules, and each of the plurality of adjustment units is arranged on an axis of a corresponding light-emitting module on the same side of the light-exit paths of the plurality of light-emitting modules;
an adjustment unit of the plurality of adjustment units comprises a lens barrel, a support barrel, a current coil and a magnetic unit;
the lens module is fixedly arranged in the lens barrel, and the lens barrel is sleeved in the support barrel, wherein a side of the support barrel facing away from the corresponding light-emitting module is provided with a first opening, and the lens barrel is capable of moving relatively in the first opening under an action of an external force; a sidewall of the lens barrel is provided with a limit protrusion for limiting a relative movement distance of the lens barrel;
the current coil is arranged on a sidewall of the lens barrel and on a side of the limit protrusion facing the corresponding light-emitting module; the magnetic unit is arranged on a side of the current coil facing the corresponding light-emitting module; the current coil is configured to generate a magnetic field signal according to the first control signal and cooperate with the magnetic unit to provide a force driving the lens barrel to relatively move by a preset distance to adjust a spacing between the lens module and the corresponding light-emitting module.
